(19) United States
(12) Patent Application Publication
(10) Pub. No.: US 2013/0216872 A1
(43) Pub. Date: Aug. 22, 2013

(54) PRISMATIC ELECTROCHEMICAL CELL

(71) Applicant: Johnson Controls Technology Company, (US)

(72) Inventors: Jason D. Fuhr, Sussex, WI (US); Gary P. Houchin-Miller, Milwaukee, WI (US); Jeffrey L. Swoyer, Port Washington, WI (US); Anthony C. Pacheco, Thiensville, WI (US); Xugang Zhang, Milwaukee, WI (US); Kem M. Obashih, Brookfield, WI (US)

(73) Assignee: JOHNSON CONTROLS TECHNOLOGY COMPANY, Holland, MI (US)

(21) Appl. No.: 13/770,784

(22) Filed: Feb. 19, 2013

Related U.S. Application Data
(60) Provisional application No. 61/601,507, filed on Feb. 21, 2012.

(51) Int. Cl. H01M 2/20; H01M 2/02; H01M 2/10

(52) U.S. Cl. CPC H01M 2/206; H01M 2/1077; H01M 2/0237
USPC 429/82; 429/178; 429/161; 429/72

(57) ABSTRACT

Systems are disclosed for battery modules having a plurality of electrochemical cells and cooling systems. According to one embodiment, a battery system includes a plurality of battery modules. Each battery module includes a plurality of electrochemical cells in thermal contact with a heat sink. The heat sink may utilize a plurality of fins and a fluid (e.g., air) to cool or heat the electrochemical cells. The electrochemical cells each have a positive terminal blade and a negative terminal blade that function as external terminals for the cell. The negative terminal blade is electrically isolated from the cover of the cell and is configured to be coupled to an internal negative terminal of the cell.

### CROSS REFERENCE TO RELATED APPLICATIONS

This application claims priority from and the benefit of U.S. Provisional Application Ser. No. 61/601,507, entitled “Prismatic Electrochemical Cell,” filed Feb. 21, 2012, which is hereby incorporated by reference for all purposes.

### FIELD OF THE DISCLOSURE

The present application relates generally to the field of batteries and battery systems. More specifically, the present application relates to batteries and battery systems that may be used in vehicle applications to provide at least a portion of the motive power for the vehicle.

### BACKGROUND

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Vehicles using electric power for all or a portion of their motive power may provide numerous advantages as compared to traditional gas-powered vehicles using internal combustion engines. For example, electric vehicles may produce fewer undesirable emission products and may exhibit greater fuel efficiency. In some cases, vehicles using electric power may eliminate the use of gasoline entirely and derive the entirety of their motive force from electric power. As technology continues to evolve, there is a need to provide improved power sources, particularly battery modules, for such vehicles. For example, it is desirable to increase the distance that such vehicles may travel without the need to recharge the batteries. It is also desirable to improve the performance of such batteries and to reduce the cost associated with the battery systems.

One area of improvement that continues to develop is in the area of battery chemistry. Early electric vehicle systems employed nickel-metal-hydride (NiMH) batteries as a propulsion source. Over time, different additives and modifications have improved the performance, reliability, and utility of NiMH batteries.

More recently, manufacturers have begun to develop lithium-ion batteries that may be used in electric vehicles. There are several advantages associated with using lithium-ion batteries for vehicle applications. For example, lithium-ion batteries have a higher charge density and specific power than NiMH batteries. Stated another way, lithium-ion batteries may be smaller than NiMH batteries while storing the same amount of charge, which may allow for weight and space savings in the electric vehicle (or, alternatively, this feature may allow manufacturers to provide a greater amount of power for the vehicle without increasing the weight of the vehicle or the space taken up by the battery system).

It is generally known that lithium-ion batteries perform differently than NiMH batteries and may present design and engineering challenges that differ from those presented with NiMH battery technology. For example, lithium-ion batteries may be more susceptible to variations in battery temperature than comparable NiMH batteries, and thus systems may be used to regulate the temperatures of the lithium-ion batteries during vehicle operation. The manufacture of lithium-ion batteries also presents challenges unique to this battery chemistry, and new methods and systems are being developed to address such challenges.

It would be desirable to provide an improved battery module and/or system for use in electric vehicles that addresses one or more challenges associated with NiMH and/or lithium-ion battery systems used in such vehicles. It also would be desirable to provide a battery module and/or system that includes any one or more of the advantageous features that will be apparent from a review of the present disclosure.

### SUMMARY

According to one embodiment, a battery system includes a plurality of battery modules. Each battery module includes a plurality of electrochemical cells. The electrochemical cells each have a positive terminal blade and a negative terminal blade that function as external terminals for the cell. The negative terminal blade is electrically isolated from the cover of the cell and is configured to be coupled to an internal negative terminal of the cell.

Various refinements of the features noted above may exist in relation to the presently disclosed embodiments. Additional features may also be incorporated in these various embodiments as well. These refinements and additional features may exist individually or in any combination. For instance, various features discussed below in relation to one or more embodiments may be incorporated into other disclosed embodiments, either alone or in any combination. Again, the brief summary presented above is intended only to familiarize the reader with certain aspects and contexts of embodiments of the present disclosure without limitation to the claimed subject matter.

### DRAWINGS

Various aspects of this disclosure may be better understood upon reading the following detailed description and upon reference to the drawings in which:

FIG. 1 is perspective view of an embodiment of a vehicle having a battery module contributing all or a portion of the motive power for the vehicle;

FIG. 2 illustrates a cutaway schematic view of an embodiment of the vehicle of FIG. 1 provided in the form of a hybrid electric vehicle;

FIG. 3 is a perspective view of an embodiment of a prismatic battery cell;

FIG. 4 is an exploded view of the prismatic battery cell of FIG. 3;

FIG. 5 is a perspective view of an embodiment of a battery module having a plurality of the prismatic battery cell of FIG. 3;

FIG. 6 is a section view of the battery module of FIG. 5, taken along line 6-6;

FIG. 7 is an end view of the battery module of FIG. 5;

FIG. 8 is a perspective view of a battery system having a plurality of the battery module of FIG. 6;

FIG. 9 is a top view of the battery system of FIG. 8 depicting an air flow path through the battery system;

FIG. 10 is a perspective view of the battery system of FIG. 8 depicting the battery system components;

FIG. 11 is an exploded view of a prismatic battery cell having a tab feature;

FIG. 12 is a perspective view of the prismatic battery cell of FIG. 11;

FIG. 13 is a perspective view of a plurality of the prismatic battery cell of FIG. 11 connected in parallel; and

FIG. 14 is a perspective view of a plurality of the prismatic battery cell of FIG. 11 connected in series.

### DETAILED DESCRIPTION

The term “xEV” is defined herein to include all of the following vehicles, or any variations or combinations thereof, that use electric power for all or a portion of their vehicular motive force. As will be appreciated by those skilled in the art, hybrid electric vehicles (HEVs) combine an internal combustion engine propulsion system and a battery-powered electric propulsion system. The term HEV may include any variation of a hybrid electric vehicle, such as micro-hybrid and mild hybrid systems, which disable the internal combustion engine when the vehicle is idling and utilize a battery system to continue powering the air conditioning unit, radio, or other electronics, as well as to kick-start the engine when propulsion is desired. The mild hybrid system may apply some level of power assist to the internal combustion engine, whereas the micro-hybrid system may not supply power assist to the internal combustion engine. A plug-in electric vehicle (PEV) is any vehicle that can be charged from an external source of electricity, such as wall sockets, and the energy stored in the rechargeable battery packs drives or contributes to drive the wheels. PEVs are a subcategory of electric vehicles that include all-electric or battery electric vehicles (BEVs), plug-in hybrid vehicles (PHEVs), and electric vehicle conversions of hybrid electric vehicles and conventional internal combustion engine vehicles. An electric vehicle (EV) is an all-electric vehicle that uses one or more motors powered by electric energy for its propulsion.

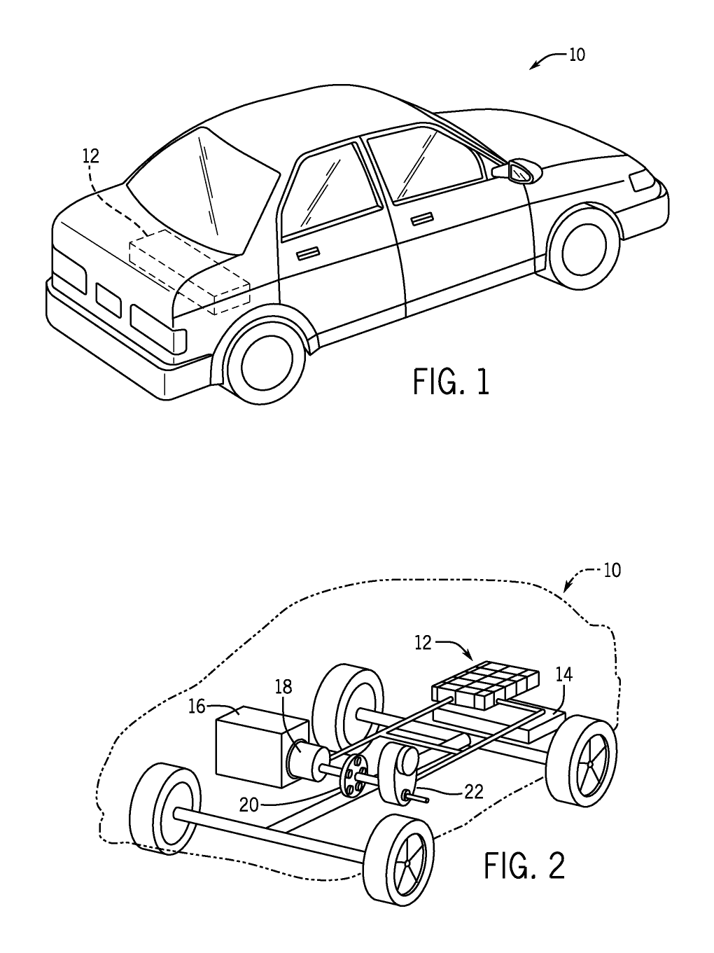

Turning now to the drawings, FIG. 1 is a perspective view of a vehicle 10 in the form of an automobile (e.g., a car) having a battery system 12 for contributing all or a portion of the motive power for the vehicle 10. Although illustrated as an automobile in FIG. 1, the type of the vehicle 10 may be implementation-specific, and, accordingly, may differ in other embodiments, all of which are intended to fall within the scope of the present disclosure. For example, the vehicle 10 may be a truck, bus, industrial vehicle, motorcycle, recreational vehicle, boat, or any other type of vehicle that may benefit from the use of electric power for all or a portion of its propulsion power.

Further, although the battery system 12 is illustrated in FIG. 1 as being positioned in the trunk or rear of the vehicle 10, according to other embodiments, the location of the battery system 12 may differ. For example, the position of the battery system 12 may be selected based on the available space within the vehicle 10, the desired weight balance of the vehicle 10, the location of other components within the vehicle 10, and a variety of other implementation-specific considerations.

For purposes of discussion, it may be helpful to discuss the battery system 12 with respect to a particular type of xEV, for example, an HEV. FIG. 2 illustrates a cutaway schematic of the vehicle 10 provided in the form of an HEV. In the illustrated embodiment, the battery system 12 is provided toward the rear of the vehicle 10 near a fuel tank 14. The fuel tank 14 supplies fuel to an internal combustion engine 16, which is provided for the instances when the HEV utilizes gasoline power to propel the vehicle 10. An electric motor 18, a power split device 20, and a generator 22 are also provided as part of the vehicle drive system. Such an HEV may be powered or driven by only the battery system 12, by only the engine 16, or by both the battery system 12 and the engine 16.

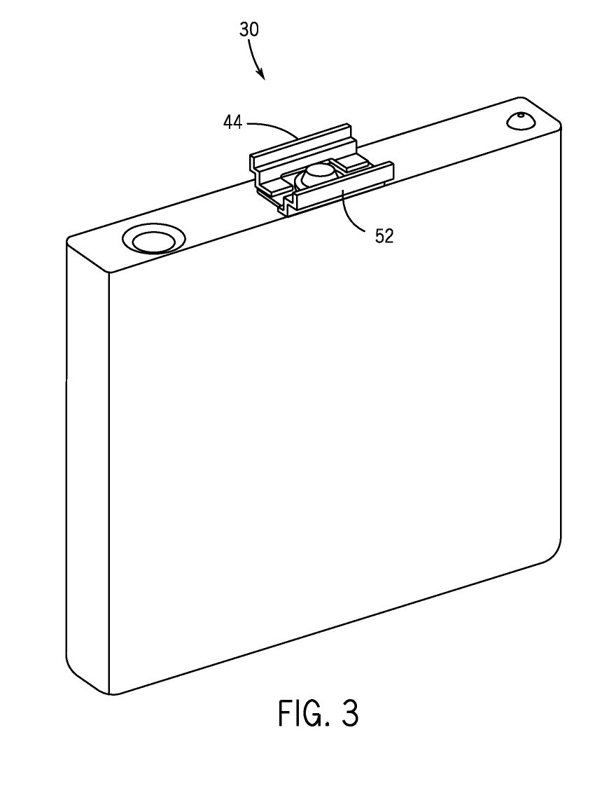

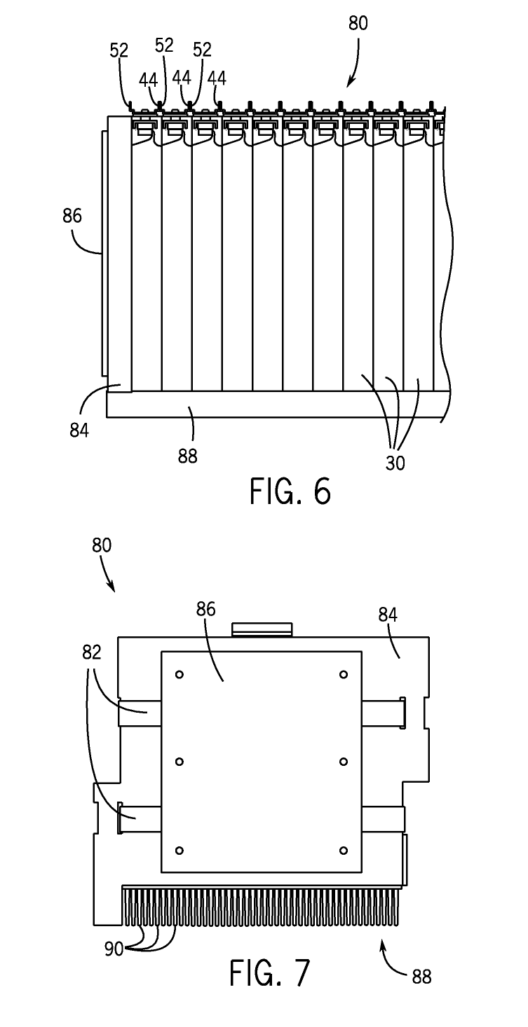

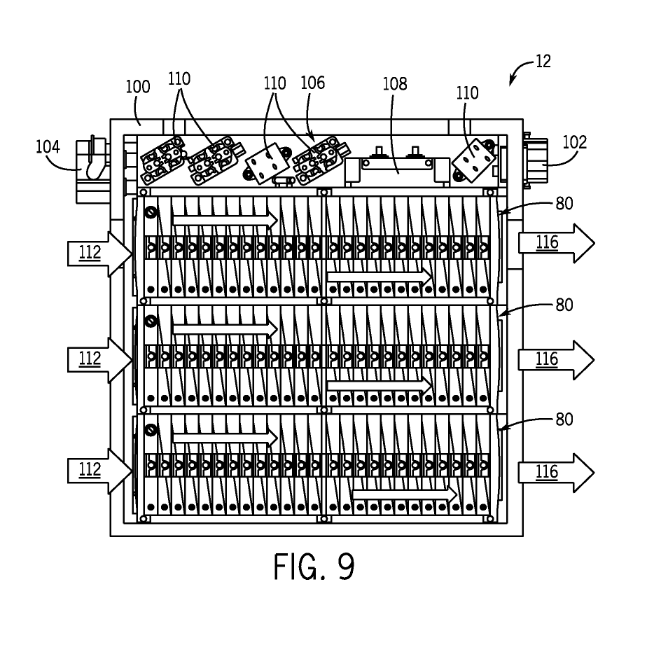

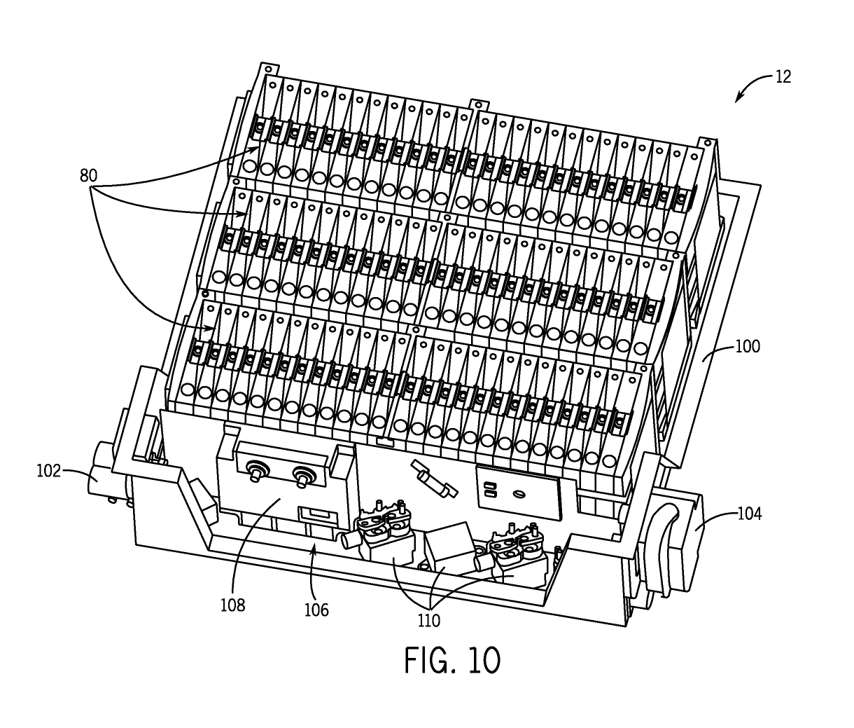

According to an embodiment, the battery system 12 includes electrochemical cells 30 or batteries (such as shown in FIGS. 3-14), and includes features or components for connecting the electrochemical cells 30 to each other and/or to other components of the vehicle electrical system, and also for regulating the electrochemical cells 30 and other features of the battery system 12. For example, the battery system 12 may include features that are responsible for monitoring and controlling the electrical performance of the system 12, managing the thermal behavior of the system 12, containment and/or routing of effluent (e.g., gases that may be vented from a battery cell 30), and other aspects of the battery system 12.

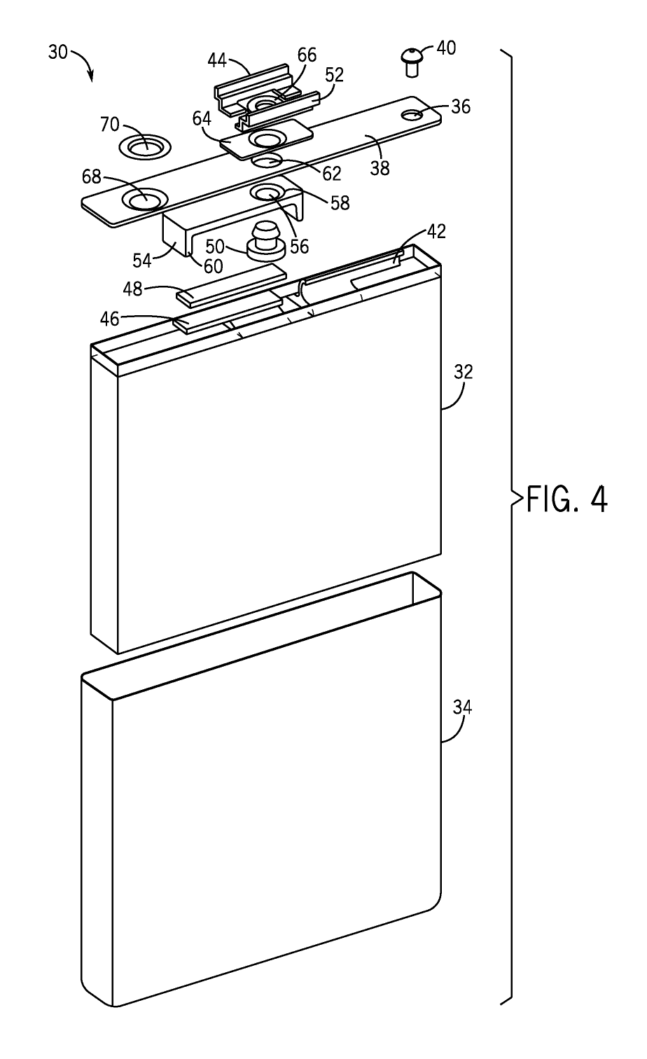

Referring now to FIGS. 3-4, the electrochemical cell 30 may be a lithium-ion cell, nickel-metal-hydride cell, lithium polymer cell, etc., or other type of electrochemical cell now known or hereafter developed. According to an embodiment, the electrochemical cell 30 is generally a prismatic lithium-ion cell configured to store an electrical charge. According to other embodiments, the cell 30 could have other physical configurations (e.g., oval, cylindrical, polygonal, etc.), and the capacity, size, design, and other features of the cell 30 may also differ from those shown.

As shown in FIG. 4, the electrochemical cell 30 includes a cell element 32 provided in a housing 34 or can. According to an embodiment, the cell element 32 includes a plurality of alternating stacked positive and negative electrode plates (not shown) that are separated from one another by an electrically insulative material (e.g., a separator). The separators (not shown) are provided intermediate to or between the positive and negative electrodes to electrically isolate the electrodes from each other. According to an embodiment, the cell 30 includes an electrolyte (not shown), and the electrolyte may be provided in the cell 30 through a fill hole 36 located in a cover 38 of the cell 30. The fill hole 36 may be plugged by a member such as a fill plug 40.

According to the embodiment shown in FIG. 4, the positive electrode plates of the cell element 32 each include a tab 42 that extends from an end (e.g., top) of each of the positive electrode plates. The tabs 42 may be crimped together and configured to be conductively coupled to an internal surface of the cover 38 of the cell 30. A positive terminal blade 44 may be conductively coupled to an external surface of the cover 38 to act as the positive terminal for the cell 30. The positive terminal blade 44 may be formed as a single integral component with the cover 38, but according to other embodiments, the positive terminal and the cover 38 may be separate components. According to the embodiment shown in FIG. 4, the positive terminal blade 44 includes a generally flat, rectangular portion that is used to electrically couple the cell 30 to an adjacent cell 30.

According to the embodiment shown in FIG. 4, the negative electrode plates of the cell element 32 each include a tab 46 that extends from an end (e.g., top) of each of the negative electrode plates. The tabs 46 may be crimped together and configured to be conductively coupled to a negative current collector 48. According to an embodiment, the negative current collector 48 is conductively coupled to a negative terminal 50, which in turn is conductively coupled to a negative terminal blade 52. The negative terminal blade 52 is configured to act as the negative terminal for the cell 30.

According to the embodiment shown in FIG. 4, the negative current collector 48 and the negative terminal 50 are electrically isolated from the cover 38 by a member shown as an insulator 54. As shown, the insulator 54 has a hole 56 (e.g., aperture) for a portion of the negative terminal 50 to extend therethrough (e.g., for electrical connection with the negative terminal blade 52). As shown in FIG. 4, the insulator 54 includes a ring 58 or projection that surrounds the hole 56 to aid in electrically isolating the negative terminal 50, as a portion of the negative terminal 50 extends through the cover 38. The insulator 54 also has side portions 60 to help electrically isolate the negative current collector 48 from the positive electrode plates.

As shown in FIG. 4, the negative current collector 48 has a generally rectangular shape. However, according to other embodiments, the negative current collector 48 may be alternatively configured. Also as shown in FIG. 4, the negative terminal 50 includes a plurality of generally cylindrically-shaped portions. However, according to other embodiments, the negative terminal 50 may be alternatively configured. The negative current collector 48 and the negative terminal 50 may be formed as separate components, but according to other embodiments, the negative current collector 48 and the negative terminal 50 may be formed as a single integral component. According to another embodiment, the cell 30 may not include a negative current collector 48. In other words, the tabs 46 of the negative electrode plates may be directly coupled to a negative terminal 50 (e.g., the negative terminal 50 shown in FIG. 4 or some other negative terminal).

According to an embodiment, the cover 38 (e.g., lid) of the cell includes a hole 62 (e.g., aperture) for the negative terminal 50 to extend therethrough. As shown in FIG. 4, a member shown as a negative terminal seal 64 is provided to seal the hole 62 (e.g., to seal electrolyte within the cell 30). Additionally, the negative terminal seal 64 is configured to electrically isolate the negative terminal blade 52 from the top of the cover 38 and from the positive terminal blade 44.

According to the embodiment shown in FIG. 4, the negative terminal blade 52 includes a generally flat, rectangular portion that is used to electrically couple the cell 30 to an adjacent cell 30. The negative terminal blade 52 also includes a second portion that extends generally perpendicularly out from a bottom of the flat, rectangular portion. The second portion includes a hole 66 (e.g., aperture) that is configured to couple with the portion of the negative terminal 50 that extends through the cover 38 of the cell 30. The negative terminal 50 may be coupled to the negative terminal blade 52 by swaging the portion of the negative terminal 50 that extends through the cover 38 of the cell 30.

According to an embodiment, the cover 38 of the cell 30 includes a hole 68 (e.g., aperture) that is covered by a member shown as a vent 70. The vent 70 may open or separate from the cover 38 of the cell 30 when the pressure inside the cell 30 increases to a predetermined pressure. As the vent 70 opens or separates from the cover 38 of the cell 30, high pressure gas and/or effluent from inside the cell 30 is allowed to be released.

The components of the cell 30 shown in FIGS. 3-4 may be constructed from various suitable materials. For example, the cell housing 34, the negative current collector 48, the negative terminal 50, the negative terminal blade 52, and the positive terminal blade 44 may be constructed from a conductive material such as copper (or copper alloy), aluminum (or aluminum alloy), or other suitable material. Additionally, the insulator 54 and/or the seal 64 may be constructed from an electrically insulative material (such as, e.g., a silicone or polymer).

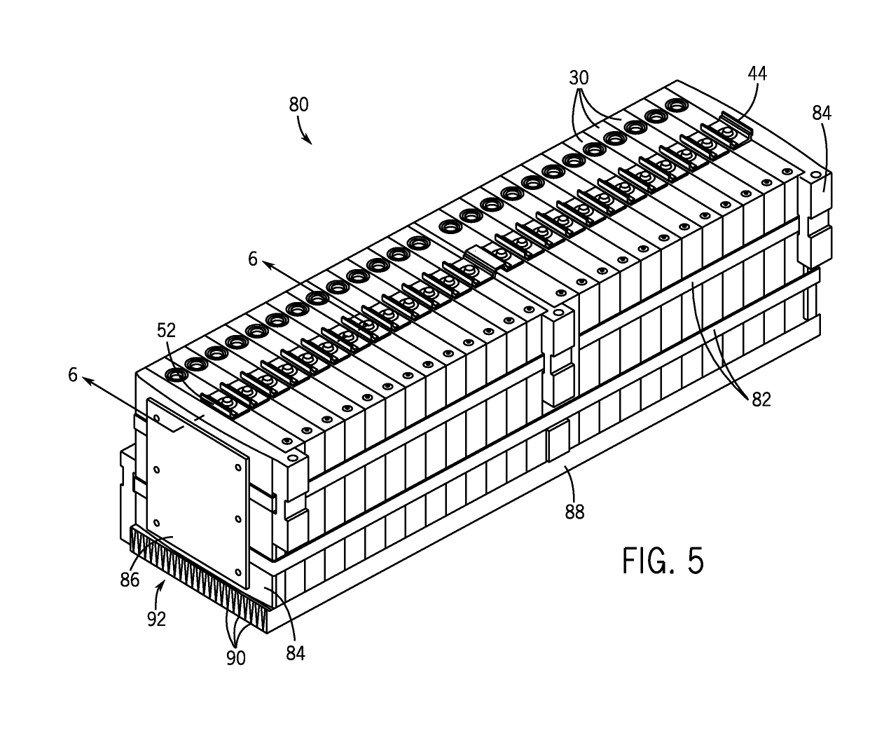

Referring now to FIGS. 5-7, a battery module 80 is shown according to an embodiment. The battery module 80 includes a plurality of electrochemical cells 30 such as that shown in FIG. 3. The electrochemical cells 30 may be lithium-ion cells, nickel-metal-hydride cells, lithium polymer cells, etc., or other types of electrochemical cells now known or hereafter developed. According to an embodiment, the electrochemical cells 30 are generally prismatic lithium-ion cells configured to store an electrical charge, although the cells 30 could have other physical configurations (e.g., oval, cylindrical, polygonal, etc.). The capacity, size, design, and other features of the cells 30 may also differ from those shown.

According to the embodiment as shown in FIG. 5, the battery module 80 includes twenty-four electrochemical cells 30 (such as the cell shown in FIGS. 3-4) arranged face-to-face in a clamped configuration (e.g., through the use of clamping bands 82). However, according to other embodiments, a greater or smaller number of cells 30 may be included in the battery module 80, depending on the desired power of the battery module 80. According to other embodiments, the battery cells 30 may be located in a configuration other than face-to-face (e.g., side-by-side, end-to-end, etc.). Each of the cells 30 are electrically coupled to one or more other cells 30 or other components of the battery system 12, e.g., by welding (such as ultrasonic or laser welding) the negative terminal blades 52 and the positive terminal blades 44 of each of the cells 30. According to another embodiment, the terminal blades 44, 52 may be coupled together through the use of fasteners (e.g., a bolt, a clamp, or a rivet).

According to an embodiment, each battery module 80 includes at least one cell supervisory controller (CSC) (not shown) to monitor and regulate the electrochemical cells 30 as needed. A CSC may be located at each end of the battery module 80 within a module end cap 84 (e.g., as shown in FIG. 5). According to other various embodiments, the location of the CSC may be different. The CSC may be mounted on a member or trace board 86 (e.g., a printed circuit board) that is coupled to the module end cap 84. The trace board 86 includes the necessary wiring to connect the CSC to the individual cells 30 and to connect the CSC to a battery management system (BMS) of the battery system 12. The trace board 86 includes various connectors to make these connections possible (e.g., temperature connectors, electrical connectors, voltage connectors, etc.).

According to the embodiment shown in FIGS. 5-7, the battery module 80 includes a heat sink 88. As shown in FIGS. 5-7, the heat sink 88 is located generally underneath a bottom of the cells 30 and extends along the entire length of the battery module 80. However, according to other embodiments, the heat sink 88 may be alternatively located or configured. The heat sink 88 includes a plurality of fins 90 that define passages 92 for air (or other fluid) to flow therethrough to provide cooling/heating to the cells 30 of the battery module 80. According to an embodiment, the heat sink 88 is provided in direct contact with the cells 30. According to another embodiment, the heat sink 88 is electrically insulated from the cells 30 by an electrically insulating, yet highly thermally conductive material.

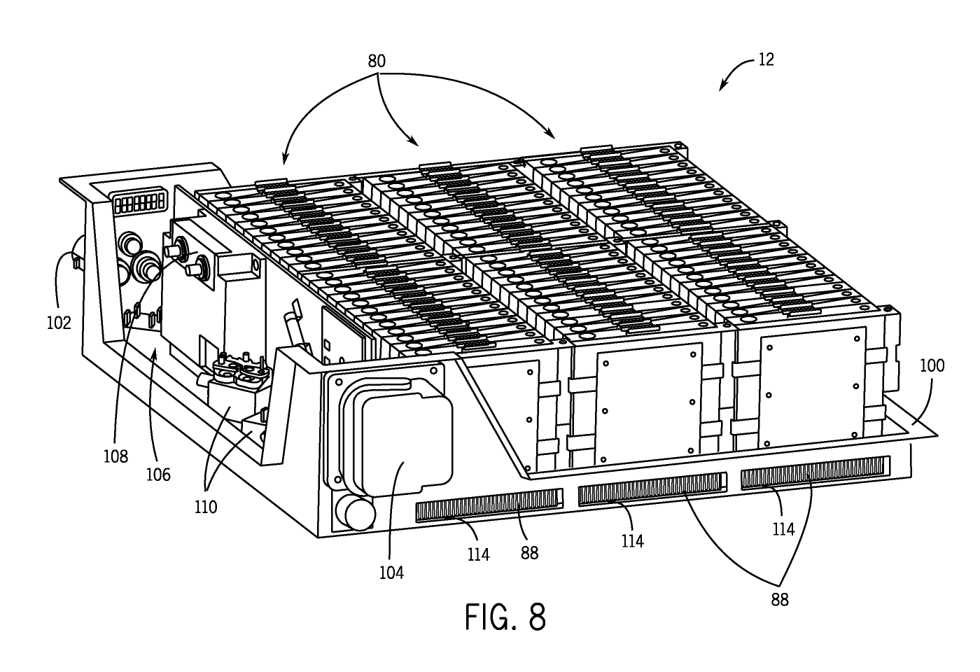

Referring now to FIGS. 8-10, the battery system 12 includes three battery modules 80 (such as, e.g., the battery module 80 shown in FIGS. 5-7) located side-by-side inside a housing 100 (shown with the cover removed for clarity). According to other embodiments, more or less battery modules 80 may be included in the battery system 12, depending on the desired power of the battery system 12. According to other embodiments, the battery modules 80 may be located in a configuration other than side-by-side (e.g., end-to-end, etc.). The housing 100 may include a member or cover (not shown) that encloses the components of the battery system 12.

As shown in FIGS. 8-10, the battery system 12 includes a high voltage connector 102 located at one end of the battery system 12 and a service disconnect 104 located at a second end of the battery system 12 opposite the first end, according to an embodiment. The high voltage connector 102 connects the battery system 12 to the vehicle 10. The service disconnect 104, when actuated by a user, disconnects the individual battery modules 80 from one another, thus lowering the overall voltage potential of the battery system 12 to allow the user to service the battery system 12. The battery system 12 further includes a battery disconnect unit (BDU) module 106 as shown in FIGS. 8-10. The BDU module 106 includes an electronic control unit shown as a battery management system (BMS) 108 that regulates the current, voltage, and/or temperature of cells in a battery module. The BDU module 106 also includes various electronic components 110 (such as, e.g., contactors, relays, connectors, etc) for the battery system 12.

Still referring to FIGS. 8-10, a thermal management device, such as, for example, a fan (not shown) is used to provide (e.g., force) a fluid (e.g., air) through the heat sinks 88 of each of the battery modules 80. As shown via arrows 112, the fluid enters the heat sinks 88 through openings 114 in the housing 100 of the battery system 12, and travels from a first side of the battery system 12 to a second side of the battery system 12. At the second side of the battery system 12, the fluid exits the battery system 12, as shown via arrows 116. The fluid may be drawn (pulled) through the battery modules 80, or the fluid may be blown (pushed) through the battery modules 80. The fluid is typically used to cool the electrochemical cells 30 in the battery modules 80, although the fluid may be used to heat the electrochemical cells 30 in the battery modules 80. According to an embodiment, the fluid is sealed (e.g., contained) from the rest of the components of the battery system 12.

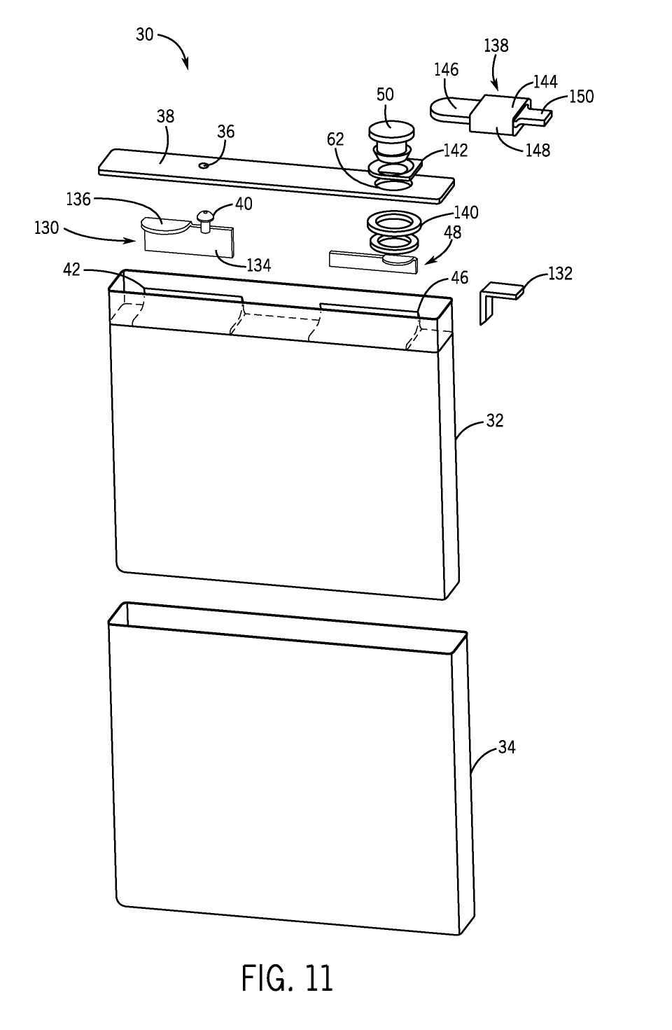

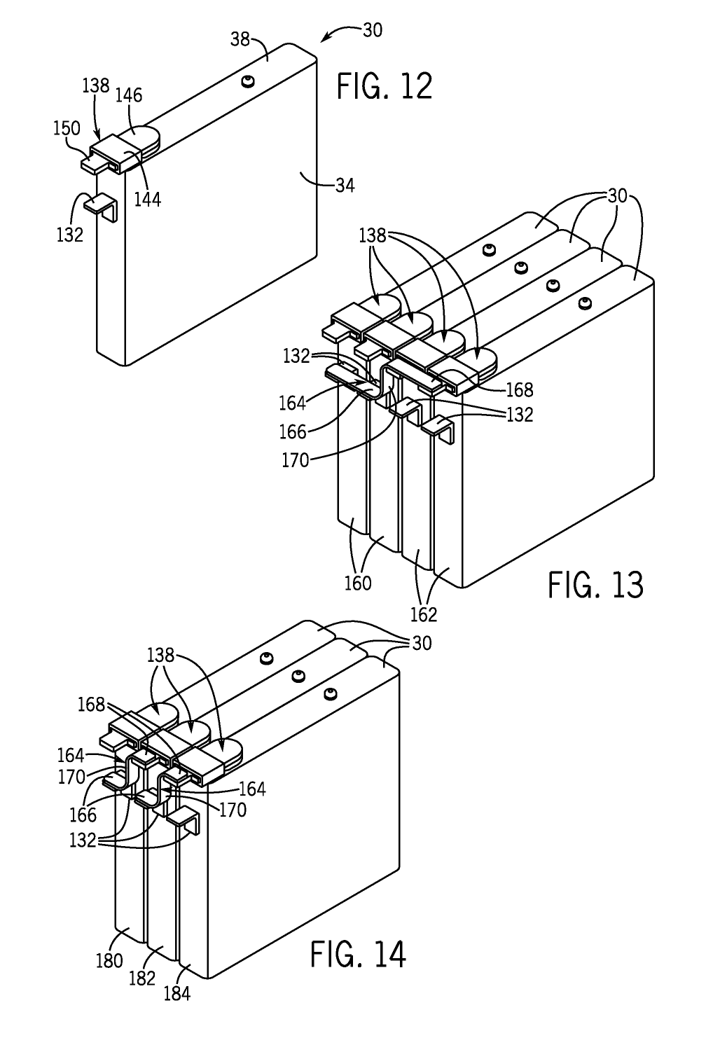

Referring now to FIGS. 11-12, an embodiment of an electrochemical cell 30 is shown. The electrochemical cell 30 may be a lithium-ion cell, nickel-metal-hydride cell, lithium polymer cell, etc., or other type of electrochemical cell now known or hereafter developed. The electrochemical cell 30 is generally a prismatic lithium-ion cell configured to store an electrical charge, although the cell 30 could have other physical configurations (e.g., oval, cylindrical, polygonal, etc.). The capacity, size, design, and other features of the cell 30 may also differ from those shown.

As shown in FIG. 11, the electrochemical cell 30 includes the cell element 32 provided in the housing 34 (e.g., a can). The cell element 32 includes a plurality of alternating stacked positive and negative electrode plates (not shown) that are separated from one another by an electrically insulative material (e.g., a separator). The separators (not shown) are provided intermediate or between the positive and negative electrodes to electrically isolate the electrodes from each other. The cell 30 also includes an electrolyte (not shown). According to an embodiment, the electrolyte is provided in the cell 30 through the fill hole 36 located in the cover 38 of the cell 30, and the fill hole 36 is plugged by the fill plug 40.

According to the embodiment shown in FIG. 11, the positive electrode plates of the cell element 32 each include the tabs 42 that extend from an end (e.g., top) of each of the positive electrode plates. The tabs 42 may be crimped together and configured to be conductively coupled to a positive current collector 130. The positive current collector 130, in turn, is configured to be conductively coupled to an internal surface of the cover 38 of the cell 30. The cover 38, in turn, is configured to be conductively coupled to the housing 34. A member, shown as a positive flange 132, is conductively coupled to the housing 34 and acts as the positive terminal for the cell 30 (e.g., for coupling with an adjacent cell 30).

According to an embodiment, the positive current collector 130 has a first portion 134 having a generally rectangular shape and configured to be coupled to the tabs 42 of the positive electrode plates. A second portion 136 of the positive current collector 130 extends out from a top of the first portion 134 at a generally right angle and is configured to be coupled to the internal surface of the cover 38. However, according to other embodiments, the positive current collector 130 may be otherwise configured.

According to an embodiment, the positive flange 132 has a generally L-shape configuration and is located at a top portion of the housing 34 (e.g., on an edge of the cell 30). However, according to other embodiments, the positive flange 132 may be otherwise configured or located.

According to the embodiment shown in FIG. 11, the negative electrode plates of the cell element 32 each include tabs 46 that extend from an end (e.g., top) of each of the negative electrode plates. The tabs 46 may be crimped together and configured to be conductively coupled to the negative current collector 48. The negative current collector 48 is conductively coupled to the negative terminal 50, which in turn is conductively coupled to a negative flange 138. The negative flange 138 is configured to act as a negative terminal for the cell 30 (e.g., for coupling with an adjacent cell 30).

According to the embodiment shown in FIG. 11, the negative current collector 48 and the negative terminal 50 are electrically isolated from the cover 38 by members shown as a bottom gasket 140 and a top gasket 142. As shown, the bottom gasket 140 and the top gasket 142 have a generally circular or annular configuration that allows the negative terminal 50 to be conductively coupled to the negative current collector 48. The negative flange 138 is electrically isolated from the cover 38 by a member shown as an insulator 144. As shown, the insulator 144 has a generally rectangular configuration that allows the negative flange 138 to be conductively coupled to the negative terminal 50, yet remain electrically insulated or isolated from the cover 38.

As shown in FIG. 11, the negative current collector 48 has a first portion 146 having a generally rectangular shape and is configured to be coupled to the tabs 46 of the negative electrode plates. A second portion 148 of the negative current collector 48 extends out from a top of the first portion 146 at a generally right angle and is configured to be coupled to a bottom portion of the negative terminal 50. However, according to other embodiments, the negative current collector 48 may be otherwise configured. As shown in FIG. 11, a washer 150 (or other similar member) may be provided between the negative current collector 48 and the negative terminal 50 to aid in the coupling of the negative current collector 48 and the negative terminal 50.

As shown in FIG. 11, the negative terminal 50 includes a plurality of generally cylindrically-shaped portions. However, according to other embodiments, the negative terminal 50 may be alternatively configured. The negative current collector 48 and the negative terminal 50 may be formed as separate components, or the negative current collector 48 and the negative terminal 50 may be formed as a single integral component. According to another embodiment, the cell 30 may not include a negative current collector 48. In other words, the tabs 46 of the negative electrode plates may be directly coupled to a negative terminal 50 (e.g., the negative terminal shown in FIG. 11 or some other negative terminal). As shown in FIG. 11, the negative flange 138 has a first portion 152 configured to be conductively coupled to a top portion of the negative terminal 50, a second or middle portion 154 configured to receive the insulator 144, and a third portion 156 configured for coupling the cell 30 with an adjacent cell 30.

According to an embodiment, the lid or cover 38 of the cell 30 includes the hole 62 or aperture for the negative terminal 50 to extend therethrough. As shown in FIG. 11, the top gasket 142 and the bottom gasket 140 are provided to seal this hole 62 (e.g., to seal electrolyte within the cell 30). Additionally, as discussed above, the top gasket 142 and the bottom gasket 140 are configured to electrically isolate the negative terminal 50 from the cover 38.

The lid or cover 38 of the cell 30 may include a hole or aperture (not shown) that is covered by a member such as a vent (as in FIG. 3). The vent may open or separate from the cover 38 of the cell 30 when the pressure inside the cell 30 increases to a predetermined pressure. As the vent opens or separates from the cover 38 of the cell 30, high pressure gas and/or effluent from inside the cell 30 is allowed to be released.

The components of the cell 30 shown in FIGS. 11-12 are constructed from various suitable materials. For example, the cell housing 34, the negative current collector 48, the negative terminal 50, the negative flange 138, the positive current collector 130, and the positive flange 132 may be constructed from a conductive material such as copper (or copper alloy), aluminum (or aluminum alloy), or other suitable material. Additionally, the insulator 144 and/or the gaskets 140, 142 may be constructed from an electrically insulative material (such as, e.g., a silicone or polymer).

Referring now to FIGS. 13-14, various configurations of connecting multiple electrochemical cells 30 (such as, e.g., the cell shown in FIGS. 11-12) are shown according to two embodiments. It should be noted that although only a few embodiments are shown in FIGS. 13-14, many more configurations or arrangements are possible, and would be within the skill of one having ordinary skill in the art.

As shown in FIG. 13, four cells 30 are shown connected together in parallel. Specifically, the first two cells 160 are connected in parallel with one another, the last two cells 162 are connected in parallel with one another, with the first two cells 160 and the last two cells 162 being connected in series. As shown in FIG. 13, the connections are made by a conductive member shown as an L-shaped bus bar 164. A first leg 166 or portion of the bus bar 164 connects the positive flanges 132 of the first two cells 160 while a second leg 168 or portion connects the negative flanges 138 of the second two cells 162. The first leg 166 and the second leg 168 of the bus bar 164 are connected to one another by an intermediate or middle portion 170.

As shown in FIG. 14, three cells 30 are shown connected together in series. Specifically, the positive flange 132 of a first cell 180 is conductively coupled with the negative flange 138 of a second cell 182, and the positive flange 132 of the second cell 182 is conductively coupled with the negative flange 138 of a third cell 184. As shown in FIG. 14, the connections are made by conductive members shown as L-shaped bus bars 164. The first leg 166 or portion of each of the bus bars 164 contacts the positive flanges 132 of the respective cells 30 while the second leg 168 or portion contacts the negative flanges 138 of the respective cells 30. The first leg 166 and the second leg 168 of each of the bus bars 164 are connected to one another by the intermediate or middle portion 170.

According to an embodiment, the bus bars 164 shown in FIGS. 13-14 may be constructed from a conductive material such as copper (or copper alloy), aluminum (or aluminum alloy), or other suitable material. The bus bars 164 shown in FIGS. 13-14 may be formed by a metal stamping or other metal forming operation.

References herein to the positions of elements (e.g., “top,” “bottom,” “above,” “below,” etc.) are merely used to describe the orientation of various elements in the figures. It should be noted that the orientation of various elements may differ according to other embodiments, and that such variations are intended to be encompassed by the present disclosure.

While only certain features and embodiments of the invention have been illustrated and described, many modifications and changes may occur to those skilled in the art (e.g., variations in sizes, dimensions, structures, shapes and proportions of the various elements, values of parameters (e.g., temperatures, pressures, etc.), mounting arrangements, use of materials, colors, orientations, etc.) without materially departing from the novel teachings and advantages of the subject matter recited in the claims. The order or sequence of any process or method steps may be varied or re-sequenced according to alternative embodiments. It is, therefore, to be understood that the appended claims are intended to cover all such modifications and changes as fall within the true spirit of the invention. Furthermore, in an effort to provide a concise description of the exemplary embodiments, all features of an actual implementation may not have been described (i.e., those unrelated to the presently contemplated best mode of carrying out the invention, or those unrelated to enabling the claimed invention). It should be appreciated that in the development of any such actual implementation, as in any engineering or design project, numerous implementation specific decisions may be made. Such a development effort might be complex and time consuming, but would nevertheless be a routine undertaking of design, fabrication, and manufacture for those of ordinary skill having the benefit of this disclosure, without undue experimentation.

1. An electrochemical cell, comprising:
a prismatic container; and
an electrode assembly configured to be disposed in the prismatic container, the electrode assembly having a plurality of positive electrode plates and a plurality of negative electrode plates, the plurality of positive electrode plates each having a first tab that extends from an end of each respective positive electrode plate, and the plurality of negative electrode plates each having a second tab that extends from an end of each respective negative electrode plate.

2. The electrochemical cell of claim 1, wherein the first tabs of each positive electrode plate are crimped together, and the second tabs of each negative electrode plate are crimped together.

3. The electrochemical cell of claim 2, wherein each respective positive electrode plate and each respective negative electrode plate is electrically isolated from one another by separators disposed between each respective positive electrode plate and each respective negative electrode plate.

4. The electrochemical cell of claim 3, having a negative current collector conductively coupled to the crimped tabs of the plurality of negative electrode plates.

5. The electrochemical cell of claim 4, having a negative terminal conductively coupled to the negative current collector and having an insulator that electrically isolates the negative terminal and the negative current collector from the prismatic container.

6. An electrochemical cell, comprising:
a prismatic container;
an electrode assembly configured to be disposed in the prismatic container, the electrode assembly having a plurality of positive electrode plates and a plurality of negative electrode plates, the plurality of positive electrode plates each having a first tab that extends from an end of each respective positive electrode plate, and the plurality of negative electrode plates each having a second tab that extends from an end of each respective negative electrode plate; and
a positive terminal blade and a negative terminal blade, the positive terminal blade configured to conductively couple with a negative terminal blade of an adjacent cell and the negative terminal blade configured to conductively couple with a positive terminal blade of at least one adjacent cell.

7. The electrochemical cell of claim 6, wherein the positive terminal blade and the negative terminal blade each include a generally flat, rectangular portion configured to conductively couple the cell to at least one adjacent cell.

8. The electrochemical cell of claim 7, wherein the positive terminal blade of the electrochemical cell is conductively coupled to the negative terminal blade of an adjacent cell or other components of a battery system by a welding process or a fastener.

9. The electrochemical cell of claim 6, wherein the first tabs of each positive electrode plate are crimped together, and the second tabs of each negative electrode plate are crimped together.

10. The electrochemical cell of claim 9, having a negative current collector conductively coupled to the crimped tabs of the plurality of negative electrode plates.

11. The electrochemical cell of claim 10, having a negative terminal conductively coupled to the negative current collector and the negative terminal blade.

12. The electrochemical cell of claim 11, having an insulator and a negative terminal seal, wherein the insulator electrically isolates the negative terminal and the negative current collector from the prismatic container, and the negative terminal seal electrically isolates the negative terminal blade from the prismatic container and the positive terminal blade.

13. The electrochemical cell of claim 9, wherein the crimped tabs of the plurality of positive electrode plates are conductively coupled to a cover of the prismatic container.

14. The electrochemical cell of claim 13, wherein the positive terminal blade is conductively coupled to the cover of the prismatic container.

15. A battery system, comprising:
a first battery module including a plurality of electrochemical cells and a heat sink;
a housing configured to contain the first battery module and a battery disconnect module that includes electronic control components of the battery system; and
a high voltage connector configured to connect the battery system to a vehicle that derives at least a portion of its motive power from the battery system.

16. The battery system of claim 15, comprising multiple battery modules.

17. The battery system of claim 16, comprising a service disconnect configured to disconnect the multiple battery modules from one another to lower the voltage potential of the battery system.

18. The battery system of claim 15, wherein the heat sink includes a plurality of fins that form a plurality of passages that enable a fluid to flow through the heat sink to provide cooling or heating to the plurality of electrochemical cells.

19. The battery system of claim 18, wherein the fluid flowing through the heat sink is air, and the air is completely contained within the heat sink.

20. The battery system of claim 15, wherein battery disconnect module includes a battery management system to regulate the current, voltage, temperature, or combination thereof of the battery system.
